(19) United States
(12) Patent Application Publication
(10) Pub. No.: US 2011/0098099 A1
(43) Pub. Date: Apr. 28, 2011

(54) VIDEO SLOT MACHINE OVERLAY

(75) Inventor: John F. Acres, Las Vegas, NV (US)

(73) Assignee: ACRES-FIORE PATENTS, Las Vegas, NV (US)

(21) Appl. No.: 12/606,979

(22) Filed: Oct. 27, 2009

(51) Int. Cl. A63F 9/24; A63F 13/00

(52) U.S. Cl. 463/20; 463/30; 463/46

(57) ABSTRACT

Embodiments of the present invention are directed to a video overlay screen. Windows within the screen are generally transparent or translucent, while other non-window portions of the screen are generally translucent or opaque. Combining the overlay screen with a typical video display gives a modified appearance to the screen that some players find attractive. In some instances the video display screen may be programmed to show a video depiction of a mechanical reel that, when combined with the overlay screen appears as if the game contains actual mechanical reels. In other embodiments the overlay screen may include a touchscreen.

### FIELD OF THE INVENTION

This disclosure relates generally to gaming devices, and more particularly to a gaming device having a realistic physical three-dimensional appearance.

### BACKGROUND

Slot machines and other mechanized gaming devices were developed over 100 years ago. Original slot machines included a set of free-spinning mechanical drums, or reels, which were simultaneously or sequentially stopped using various mechanisms. After the reels stopped, the machine dropped coins into a hopper to pay awards based on the position of the stopped reels.

Major advancements on this basic technology have been directed toward providing a more entertaining gaming experience for the player with simultaneous lower capital or operating expense to the casino operator. Coin hoppers that required frequent refill gave way to bar-coded tickets by which players establish and receive game credit. Other advances replaced the free-spinning mechanical reels, which required costly maintenance, with extremely lightweight reelstrip framework structures. Now stepper motors efficiently and accurately drive the spinning and stopping action of the reelstrip framework to appear similar to the original free-spinning mechanical reels. In recent years even the motor driven reelstrips have been largely supplanted by modern electronic video screens programmed to display a facsimile image of a spinning reel.

Embodiments of the invention are directed to a system that modifies the appearance of a modem gaming device.

### BRIEF DESCRIPTION OF THE DRAWINGS

FIG. 1 is an isometric view of a conventional gaming device that includes a video screen display.

FIG. 2 is an isometric view of a conventional gaming device that includes spinning reels.

FIG. 3 is a side view of a gaming device including an overlay according to embodiments of the invention.

FIG. 4 is a front view of a screen overlay according to embodiments of the invention.

FIG. 5 is a front view of the screen overlay of FIG. 4 combined with output from a video display from the gaming device of FIG. 3.

FIG. 6 is a front view of a video display modified to accommodate the screen overlay of FIG. 4 according to embodiments of the invention.

FIG. 7 is a side view of a screen overlay system according to embodiments of the invention.

FIGS. 8A and 8B are related front views of a screen overlay system including a touchscreen according to embodiments of the invention.

### DETAILED DESCRIPTION

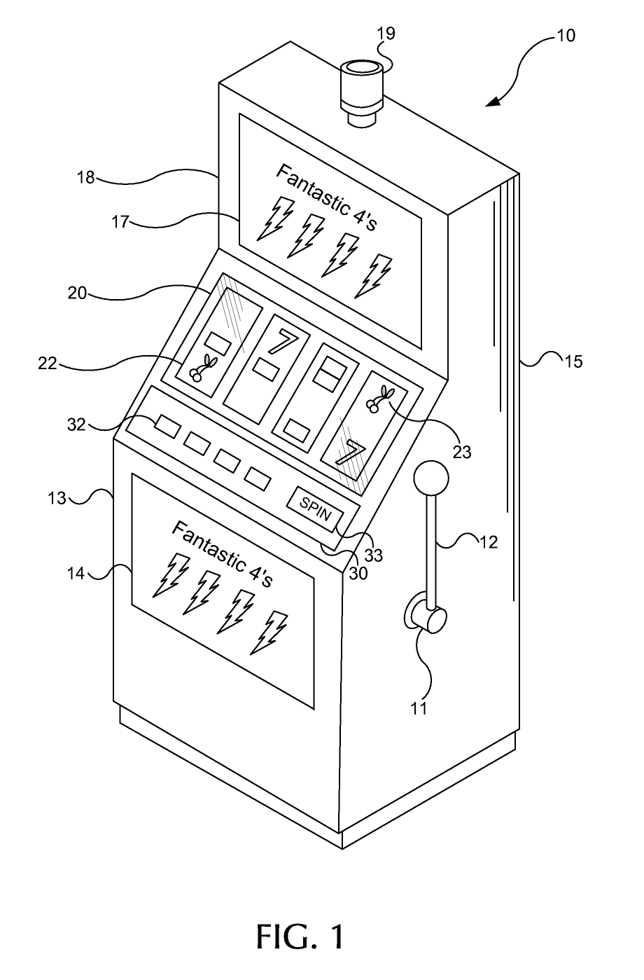

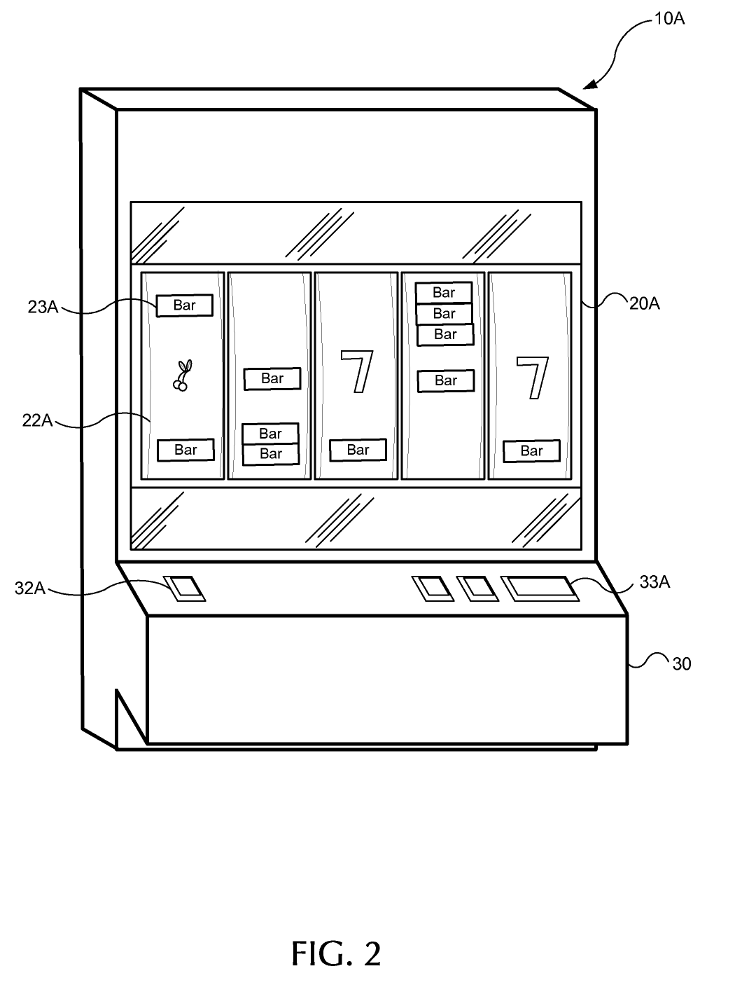

FIGS. 1 and 2 illustrate conventional display screens on gaming devices. Referring to FIG. 1, a gaming device 10 is an electronic gaming machine or “slot” machine, which includes video slot machines and video poker machines, for instance. The gaming device 10 of FIG. 1 includes a cabinet 15 housing components to operate the gaming device 10. The cabinet 15 may include a gaming display 20, a base portion 13, a top box 18, and a player interface panel.

The gaming display 20 of FIG. 1 is a video display, upon which a video sequence is shown. In a common example, the video sequence shows multiple video reels 22. In the example of FIG. 1 there are four reels 22 illustrated. Each of the reels is programmed to include a number of individual symbols 23. In operation, during a game the gaming display 20 is driven so that it appears to the player that the reels 22 are spinning and eventually stop, resting with a particular set of symbols 23, one for each reel 22, on one or more paylines. The game evaluates the combination of symbols 23 on the payline and, if the combination is a winning combination, pays an award to the player.

The base portion 13 of the gaming device 10 may include a lighted panel 14, a coin return (not shown), and a gaming handle 12 operable on a partially rotating pivot joint 11. The game handle 12 is traditionally included on mechanical spinning-reel games, where the handle may be pulled toward a player to initiate the spinning of reels 22 after placement of a wager. The top box 18 may include a lighted panel 17, a video display (such as an LCD monitor, not shown), a mechanical bonus device (not shown), and a candle light indicator 19. The player interface panel 30 may include various devices so that a player can interact with the gaming device 10. For example, the player interface panel 30 may include one or more game buttons 32 that can be actuated by the player to cause the gaming device 10 to perform a specific action. Some of the game buttons 32 cause the gaming device 10 to wager credits during the next game, change the number of lines being played on a multi-line game, cash out the credits remaining on the gaming device, or request assistance from casino personnel, such as by lighting the candle 19. In addition, the player interface panel 30 may include one or more game actuating buttons 33, which initiate a game with a pre-specified amount of credits.

The gaming display 20A of FIG. 2 includes a series of five mechanical reels 22A, which in most cases are include the reelstrip frames and reelstrips described above. Typically, spinning-reel gaming machines 10A have three to five spinning reels 22A. Each of the spinning reels 22A has multiple symbols 23A that may be separated by blank areas on the spinning reels 22A, although the presence of blank areas typically depends on the number of reels 22A present in the gaming device 10A and the number of different symbols 23A that may appear on the spinning reels 22A. Each of the symbols 22A or blank areas makes up a “stop” on the spinning reel 22A where the reel 22A comes to rest after a spin. Although the spinning reels 22A of various games 10A may have various numbers of stops, many conventional spinning-reel gaming devices 10A have reels 22A with twenty two stops.

During game play, the spinning reels 22A are controlled by microprocessor-driven stepper motors (not shown). Thus, although the spinning-reel gaming device 10A has mechanical based spinning reels 22A, the movement of the reels themselves is electronically controlled to spin and stop. This electronic control is advantageous because it allows a virtual reel strip to be stored in the memory 41 of the gaming device 10A, where various “virtual stops” are mapped to each physical stop on the physical reel 22A. This mapping allows the gaming device 10A to establish greater awards and bonuses available to the player because of the increased number of possible combinations afforded by the virtual reel strips.

A gaming session on a spinning reel slot machine 10A typically includes the player pressing a wager button, such as the “bet-one” button (one of the game buttons 32A) to wager a desired number of credits followed by pulling the gaming handle 12 (FIGS. 1A, 1B) or pressing the spin button 33A to spin the reels 22A. Alternatively, the player may simply press the “max-bet” button (another one of the game buttons 32A) to simultaneously wager the maximum number of credits permitted and initiate the spinning of the reels 22A. The spinning reels 22A may all stop at the same time or may individually stop one after another (typically from left to right) to build player anticipation. Because the display 20A usually cannot be physically modified, some spinning reel slot machines 10A include an electronic display screen in the top box 18 (FIG. 1B), a mechanical bonus mechanism in the top box 18, or a secondary display 25 (FIG. 1A) to execute a bonus.

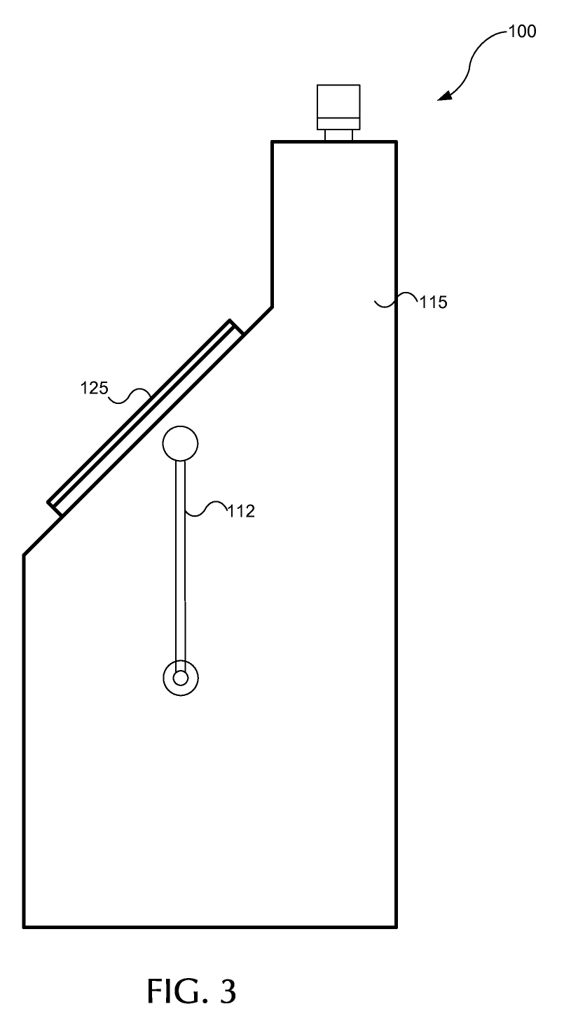

FIG. 3 is a side view of a gaming device 100 according to embodiments of the invention. The gaming device 100 includes a basic cabinet 115 and, in some embodiments, a pull handle 112 for initiating a game. Also included on the gaming device 100 is an overlay screen 125, which is mounted on or within the gaming device 100. The overlay screen 125 sits “on” or over a video display 120, which is not visible in FIG. 3.

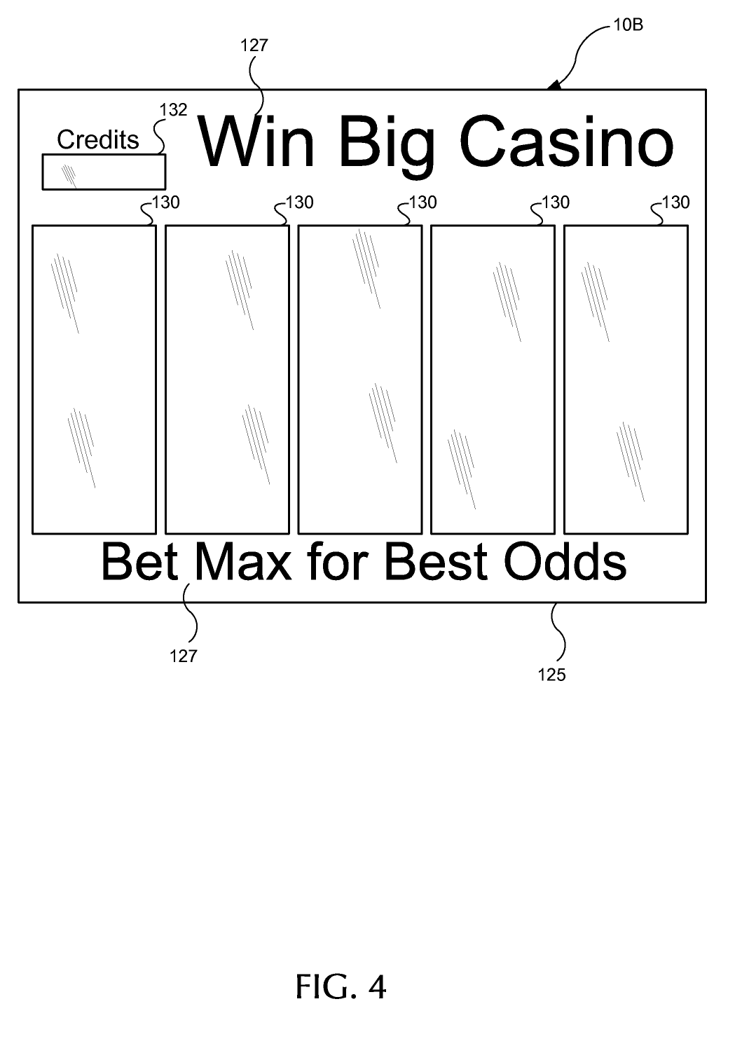

FIG. 4 is a top-view drawing of the overlay screen 125. Central to the overlay screen 125 are a series of reel windows 130, one window for each reel that is illustrated on the video display 120. In a typical embodiment, the overlay screen 125 is made of glass, plastic, or other transparent or nearly transparent material. While some overlay screens 125 may include printing, screening, or other markings, reel windows 130 remain relatively clear. When positioned over the video display 120, projections from the underlying video display are shown to and seen by the player through the individual reel windows 130. Specifically, and preferably, the reel windows 130 include borders that generally conform to the size and position of the underlying reels on the video display 120. For example, if the video display 120 includes 3 reels, then there are three corresponding reel windows 130 in the overlay screen 125. If the video display 120 instead includes five reels, then the overlay screen 125 would include five reel windows 130, such as illustrated in FIG. 4.

Other windows 132 may correspond to other informative portions of the video display 120. For example, one of the windows 132 in FIG. 4 corresponds to an area of the video display that shows the present number of credits that player possesses. The player can then see the number of credits through the window 132 when the number of credits is shown on the underlying video display 120.

In addition to the other windows 130, the overlay screen 125 includes areas that may be tinted, painted, or otherwise covered. The coverings may be opaque or may be translucent. In the embodiment illustrated in FIG. 4 the coverings include text portions 127 that may include instructions for the player or general logos or other advertising.

Because of the properties of the overlay screen 125, viewing the underlying video display 120 through the overlay screen may give the appearance that the gaming device 100 includes mechanical reels, where, in fact, the reels are actually projections from the video display 120. This appearance is appealing to many players, especially those with a fondness for the older style, mechanical spinning reels or reelframes with reelstrips. At the same time, a video display 120 is less expensive and has lower maintenance operating costs than mechanical reels.

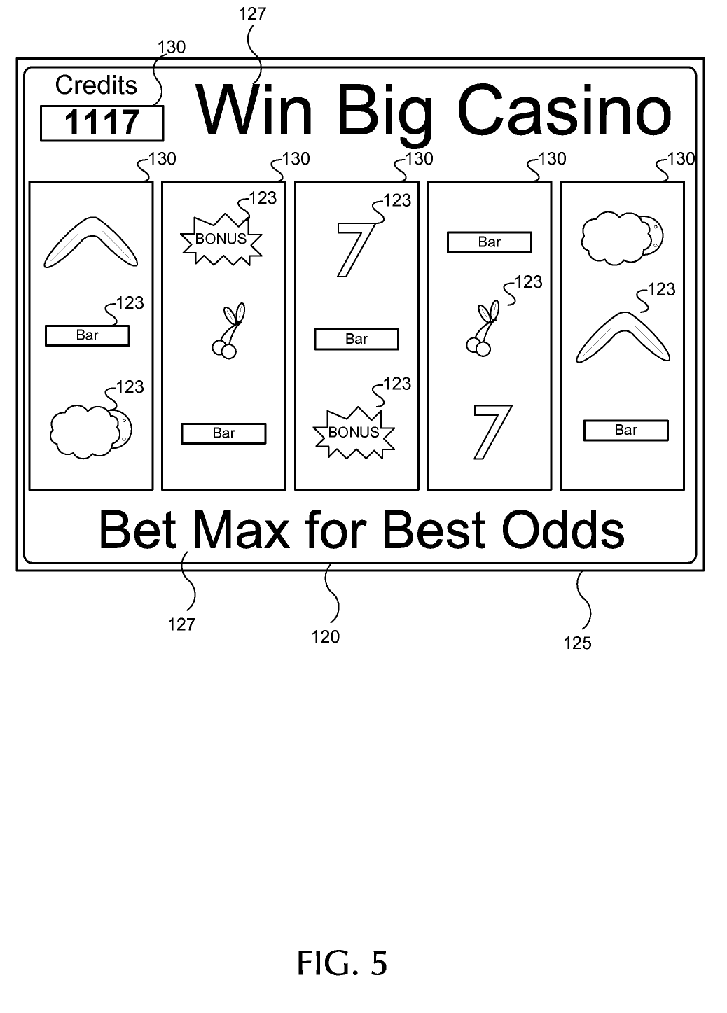

FIG. 5 illustrates the overlay screen 125 combined with an underlying video display 120. Symbols 123 shown on reels 122 of the video display 120 are easily seen through the clear windows 130 of the overlay screen 125. A distance between the video display 120 and the player of the gaming device 100 can be controlled by several factors. In some instances, the overlay screen 125 has a physical thickness that, when overlayed on the video display 120, just matches a desired distance. In other embodiments, spacers or blocks (not shown) may physically separate the video display 120 from the overlay screen 125. In other embodiments the display screen 120 may be sunken into the cabinet 115, while the overlay screen 125 rests on the cabinet surface.

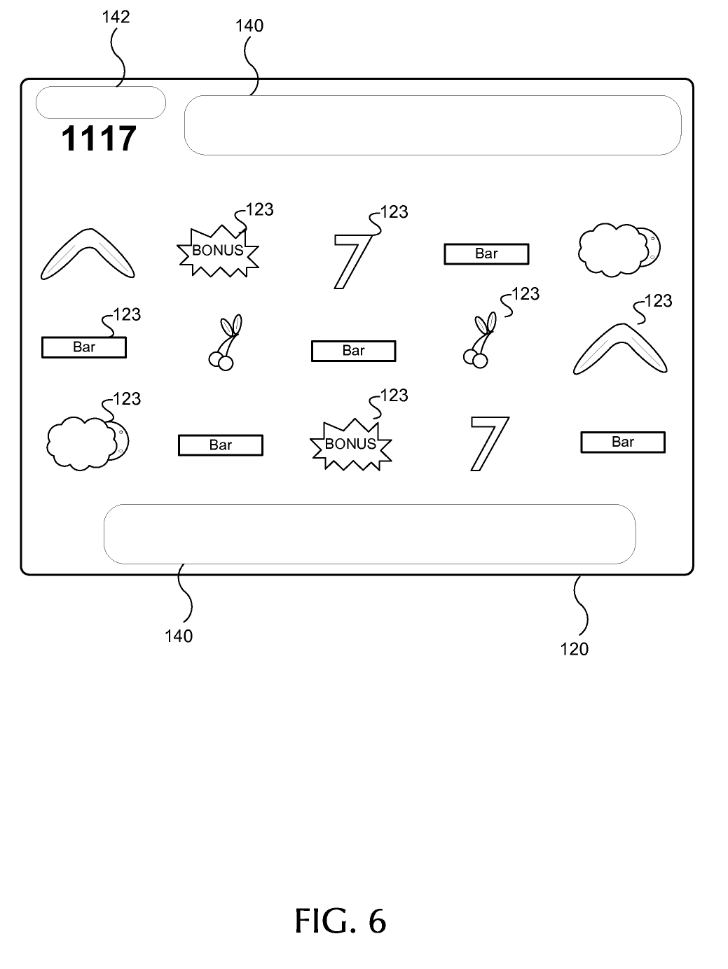

Modifications may be made to sequences of images on the video display 120 to further enhance the attractiveness and usefulness of the overlay screen 125. Specifically, to make it appear as if the overlay screen 125 were backlit with lights, portions of the video display 120 may be made brighter, and in some cases much brighter, than if the overlay screen 125 were not present. For example, with reference to FIG. 6, the video display 120 includes two light areas 140 that correspond to the text portions 127 of the overlay screen 125 in FIG. 4. The light areas 140 are brightly driven, such as bright white, which, when combined with the text areas 127 appears as if the overlay screen 125 were backlit. The light areas 140 need not be driven white, but may be driven to a certain color that is attractive when combined with the translucent text area 127. Even when the text area 127 is opaque, the light areas 140 can be driven to an attractive, complementary color where the light may bleed around the sides of an opaque area 127. Other light areas 142 similarly light other portions of the overlay screen 125 that are made more attractive when backlit. A video driver (not illustrated) of the video display 120 may be programmed or otherwise determine when an overlay screen 125 is present. If the overlay screen 125 is present, the video driver drives the light areas 140, 142 with an increased intensity. If the overlay screen 125 is not present, the standard intensity is used.

One drawback to the embodiment of the overlay screen 125 described above is that the overlay screen must be physically changed should the format of the game shown on the video display screen 120 be changed. For example, if the game on the gaming device is a three-reel game, and the overlay screen 125 correspondingly includes three reel windows 130, then no four or five reel games could be played on the gaming device without physically changing the overlay screen 125.

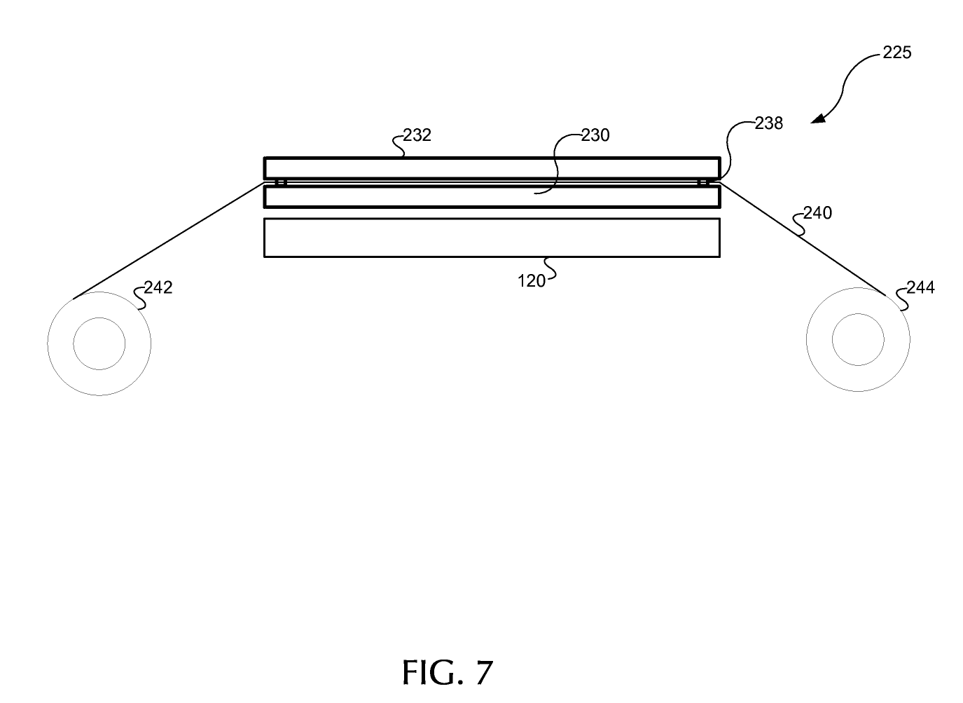

FIG. 7 illustrates another embodiment of a video overlay screen. In this example, a video overlay screen 225 includes a base portion 230 which is mounted most near the video display screen 120 upon which the game is displayed. An upper portion 232 is separated from the base portion 230 by spacers 238. Running between the upper and lower portions 230, 232 is a flexible substrate 240 upon which an overlay screen 245 is printed. In the illustrated embodiment the substrate 240 is wound around a pair of rolls 242, 244. In operation, the rolls 242, 244 are controlled by, for instance, a positioning motor (not illustrated) to direct a particular screen 245 on the substrate 240 to a position between the upper and lower portions 230, 232 of the overlay screen 225. The upper and lower portions 230, 232, may be clear or translucent. The player views the display screen 120 through the combination of the upper and lower portions 230, 232, as well as the overlay screen 245. In this manner multiple overlay screens 245 may be included within a single game cabinet, eliminating a need to physically change an overlay screen each time a game within a game cabinet changes.

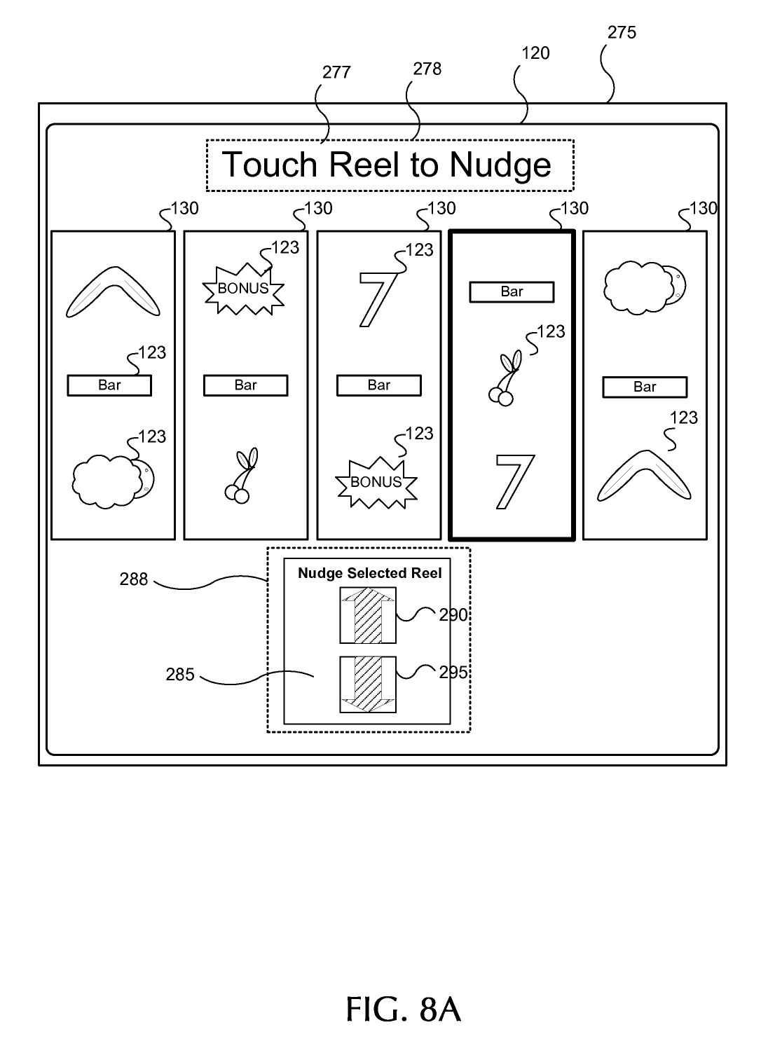

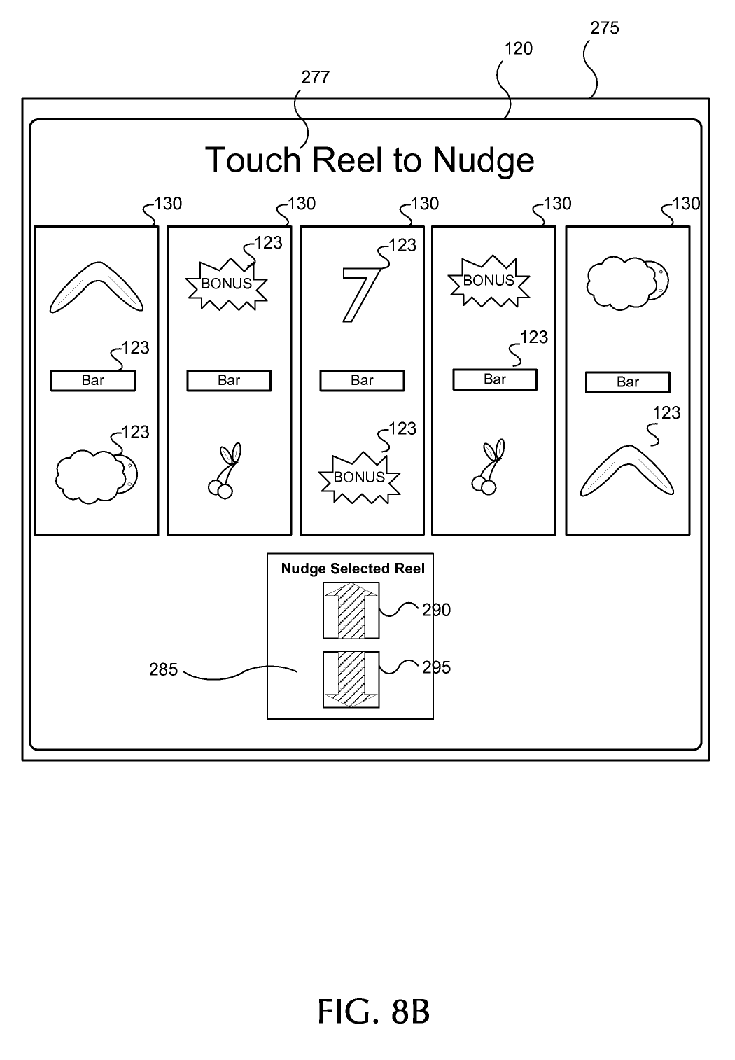

Although described above as being made from glass or plastic, the overlay screen according to embodiments of the invention may additionally include touchscreen functions. With reference to FIG. 8A, a see-through touchscreen 275 overlays a video display 120 that is driven by the gaming device 100 of FIG. 3. In this example, however, a player can control functions of the game on the gaming device 100 by interacting with the touchscreen 275. For instance, assume that a player benefit awarded during a game or bonus is a nudge feature, such as that described in co-pending application Ser. No. 12/166,156, filed Jul. 1, 2008, entitled Gaming Device Configuration Based on Player Value, the teachings of which are incorporated by reference herein. The overlay touchscreen 275 can help implement such a feature. For instance, assume that a player is awarded a nudge as a bonus feature. A text area 277 is illuminated by selectively lighting a portion of the video display 120 that underlies the text area to inform the player that such a bonus is available, as illustrated by the lightbox 278. The player then touches the overlay touchscreen 275 in the area of the reel the player desires to nudge. In this example the player has touched the reel second from the right, which changes form or shape to inform the player that it has been selected. In the Example in FIG. 8A the selected reel is highlighted with a thicker border. The touchscreen 275 senses which area of the touchscreen was touched by the player and communicates the information to the game. The game reacts by giving the player “control” of the particular selected reel, such as by enabling a nudge controller 285. The game informs the player that the nudge controller is enabled by illuminating the lightbox 288 by driving the video display 120 brightly in an area below the nudge controller. When the player presses either a nudge up button 290 or a nudge down button 295, the game reacts to move the selected reel to the desired position. In this example the player wishes to nudge the selected reel down, by pressing the down button 295, so that the “Bar” symbols 123 are aligned across the payline, as illustrated in FIG. 8B. The player ultimately places the reel in the desired position, as illustrated in FIG. 8B, and the game continues. Note that the text area 277 and nudge controller 285 are no longer illuminated in FIG. 8B because the player “used” the benefit.

In another embodiment, instead of the touchscreen 275 including location-delimited buttons to accept user input, such as the nudge up and nudge down buttons 290, 295 illustrated in FIG. 8B, the entire touchscreen accepts input in the form of user actions to perform a desired function. In other words, a gesture or action made by the user and sensed by the touchscreen 275 controls the underlying game. For example, a player could touch, or point to, the reel area and move or slide his finger upward to indicate a nudge up. Similarly, sliding a finger down along the touchscreen 275 over a reel causes the reel to move in a downward direction. Moving the finger multiple times or quickly indicates a larger reel movement in the direction of the finger slide. The touchscreen 275 translates such gestures into data or otherwise communicates the information to the underlying game, as described above, to cause the game to react based on the user action.

Multiple types of touchscreens 275 or other motion-recognizing technology can also sense user gestures and actions. For example the touchscreen 275 may be one of the well-known capacitive or resistive types. In some embodiments a particular stylus or other touching device may be used in conjunction with the touchscreen 275, rather than a user's finger. In yet other embodiments the touchscreen 275 function may be implemented with a video camera, heat-sensing apparatus, or other such device that accepts or tracks user movement.

Some embodiments of the invention have been described above, and in addition, some specific details are shown for purposes of illustrating the inventive principles. However, numerous other arrangements may be devised in accordance with the inventive principles of this patent disclosure. Further, well known processes have not been described in detail in order not to obscure the invention. Thus, while the invention is described in conjunction with the specific embodiments illustrated in the drawings, it is not limited to these embodiments or drawings. Rather, the invention is intended to cover alternatives, modifications, and equivalents that come within the scope and spirit of the inventive principles set out in the appended claims.

1. A gaming device comprising:
a gaming cabinet including a video display on which a game is played, the video display including a plurality of gaming areas; and
a partially transparent overlay separate from the video display and mounted to the gaming cabinet, the partially transparent overlay including a plurality of windows structured to respectively align with the plurality of gaming areas on the video display.

2. The gaming device of claim 1 in which the plurality of windows are reel windows structured to let images of spinning reels be seen therethrough, the partially transparent overlay further including at least one separate window through which information from the video display can be seen.

3. The gaming device of claim 2 in which the information from the video display comprises game credit information.

4. The gaming device of claim 1 in which the partially transparent overlay further comprises one or more information areas separate from the plurality of windows.

5. The gaming device of claim 4 in which the video display is structured to selectively show brighter in areas of the video display that correspond to the one or more information areas.

6. The gaming device of claim 5 in which the information areas contain information about the game.

7. The gaming device of claim 4 in which the information areas are opaque.

8. The gaming device of claim 1 in which the partially transparent overlay comprises a touchscreen.

9. A gaming device comprising:
a gaming cabinet including a video display on which a game is played, the video display including a plurality of gaming areas; and
a replaceable screen separate from the video display and disposed between the video display and a player of the gaming device, the replacement screen including a plurality of windows structured to respectively align with the plurality of gaming areas on the video display.

10. The gaming device of claim 9 in which the replaceable screen is one of a plurality of screens and in which the gaming device is structured to change from one of the plurality of screens to another of the plurality of screens when a game on the gaming device changes.

11. The gaming device of claim 10 in which the plurality of screens are formed on a substrate and in which the gaming device is structured to control a position of the substrate.

12. The gaming device of claim 11 in which the replaceable screen moves in a track.

13. The gaming device of claim 9, further comprising a touchscreen structured to accept input from a player and communicate the input to the game on the gaming device.

14. A method of presenting a game on a gaming device, comprising:
generating game output on a video display; and
showing the game output to a player of the game through an overlay screen that has a plurality of transparent windows formed therein.

15. The method of claim 14 in which the game output is positioned on the video display to align with the plurality of transparent windows on the overlay screen.

16. The method of claim 14 in which the overlay screen is a touchscreen, the method further comprising accepting input from a player through the touchscreen.

17. The method of claim 16 further comprising sending the accepted input to a game controller.

18. The method of claim 17 further comprising modifying the game output based on the accepted input.

19. The method of claim 14 further comprising generating light areas on the video display that correspond with non-window portions of the overlay screen.

20. The method of claim 19 in which the light areas are generated to inform the player about a game event.
